(19) United States
(12) Patent Application Publication
(10) Pub. No.: US 2023/0222407 A1
(43) Pub. Date: Jul. 13, 2023

(54) System and Method of Shift and Operative Match Optimization

(71) Applicant: Verizon Patent and Licensing Inc., Basking Ridge, NJ (US)

(72) Inventors: Caroline Gallrein Schmidt, Chicago, IL (US); Minkyung Kim, Berkeley Heights, NJ (US); Mark Romanak, Lone Tree, CO (US)

(21) Appl. No.: 17/575,359

(22) Filed: Jan. 13, 2022

(51) Int. Cl. G06Q 10/06

(52) U.S. Cl. CPC G06Q 10/063112; G06Q 10/06398

(57) ABSTRACT

An illustrative method includes a computing system receiving a request from an entity to fill a shift associated with a task. The method further includes accessing values for a set of shift criteria associated with the entity and the shift and accessing values for a set of operative criteria associated with an operative. The method further includes determining, based on the values for the set of shift criteria and the values for the set of operative criteria, a value for a compatibility rating of the operative with the shift. The method further includes providing, by the computing system, an output based on the value for the compatibility rating of the operative with the shift.

### BACKGROUND INFORMATION

Companies, factories, and other such entities may hire workers for shift work. The number of employees and the quality of those employees hired for each shift may directly impact productivity and efficiency for the entity. Further, there may be instances when hired workers do not show up for their shifts, at which point more workers may need to be hired on short notice.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary computer system for shift and operative match optimization according to principles described herein.

FIGS. 2-4 illustrate exemplary configurations of systems within which the computer system of FIG. 1 may operate to perform shift and operative match optimization according to principles described herein.

FIGS. 5-6 illustrate exemplary user interfaces by which the computer system of FIG. 1 may perform shift and operative match optimization according to principles described herein.

FIGS. 7-8 illustrate exemplary methods for shift and operative match optimization according to principles described herein.

FIG. 9 illustrates an exemplary computing device according to principles described herein.

### DETAILED DESCRIPTION OF EXAMPLE EMBODIMENTS

Systems and methods for shift and operative match optimization are described herein. In certain examples, an illustrative system may be configured to receive a request from an entity to fill a shift associated with a task. The system may access values for a set of shift criteria associated with the entity and the shift. The system may access values for a set of operative criteria associated with an operative. The system may determine, based on the values for the set of shift criteria and the values for the set of operative criteria, a value for a compatibility rating of the operative with the shift. The system may provide an output based on the value for the compatibility rating of the operative with the shift.

For example, an entity may be a factory that may be hiring operatives for shifts on a factory floor. The entity may enter information associated with the shift that may be used as values for shift criteria associated with the shift. The entity may provide the shift criteria to the system, which may determine operatives that match based on the shift criteria and operative criteria associated with the respective operatives. In this manner, the system may optimize matches between shifts and operatives in real time. Additionally, the system may allow for the entity and the operatives to provide feedback upon completion of the shifts, which may further optimize future matches of shifts with operatives. Further, the system may facilitate operatives taking shifts by providing verification, documentation, payment processing, training, and other such aspects that may streamline onboarding and other such administrative and related tasks. These examples as well as additional examples of shift and operative match optimization are described in detail herein.

Systems and methods described herein may provide one or more benefits and/or advantages over conventional technologies. As an example, systems and methods described herein may allow for real time determining and optimization of matches between operatives and shifts. Further, systems and methods described herein may facilitate and streamline the working of the shifts by the operatives.

Various embodiments will now be described in more detail with reference to the figures. The disclosed systems and methods may provide one or more of the benefits mentioned above and/or various additional and/or alternative benefits that will be made apparent herein.

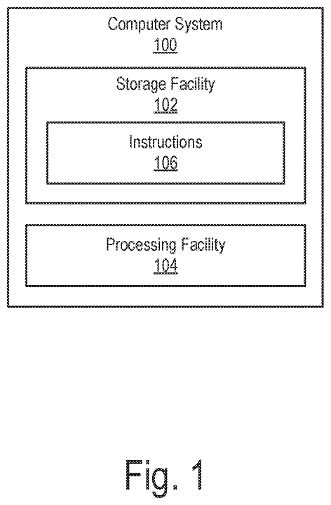

FIG. 1 illustrates an exemplary computer system 100 (“system 100”) for shift and operative match optimization. System 100 may be implemented by any suitable computer system configured to perform one or more of the operations described herein. In certain examples, system 100 may be implemented by a computer system connected to a network, such as a multi-access edge computing (“MEC”) server that is integrated within a provider network and that employs MEC technology, 5G network technologies, a local network server, and/or other suitable technologies or combination of technologies that may enable system 100 to perform the operations described herein. In certain examples, system 100 may be implemented together with other systems, devices, and/or sensors (e.g., an image capture device, a monitoring device, etc.) within an environment that is configured to operate as a single, independent system. In other examples, system 100 may be implemented separately and may operate independently from other systems, devices, and/or sensors.

As shown, system 100 may include, without limitation, a storage facility 102 and a processing facility 104 selectively and communicatively coupled to one another. Facilities 102 and 104 may each include or be implemented by hardware and/or software components (e.g., processors, memories, communication interfaces, instructions stored in memory for execution by the processors, etc.). In some examples, facilities 102 and 104 may be distributed between multiple devices and/or multiple locations as may serve a particular implementation. For example, facilities 102 and 104 may be spread across multiple processors or other distinct computing resources within a local server, a MEC server, and/or any other suitable computing system which, as will be described below, may incorporate a plurality of various servers or other resources. Each of facilities 102 and 104 within system 100 will now be described in more detail.

Storage facility 102 may maintain (e.g., store) executable data used by processing facility 104 to perform any of the functionality described herein. For example, storage facility 102 may store instructions 106 that may be executed by processing facility 104. Instructions 106 may be executed by processing facility 104 to perform any of the functionality described herein, and may be implemented by any suitable application, software, code, and/or other executable data instance. Additionally, storage facility 102 may also maintain any other data accessed, managed, used, and/or transmitted by processing facility 104 in a particular implementation.

Processing facility 104 may be configured to perform (e.g., execute instructions 106 stored in storage facility 102 to perform) various functions associated with matching shifts and operatives. Examples of such operations are described herein.

In some examples, system 100 may be configured to operate in real time so as to access and process the data described herein as quickly as the data is generated or otherwise becomes available. As used herein, operations may be performed in “real time” when they are performed immediately and without undue delay.

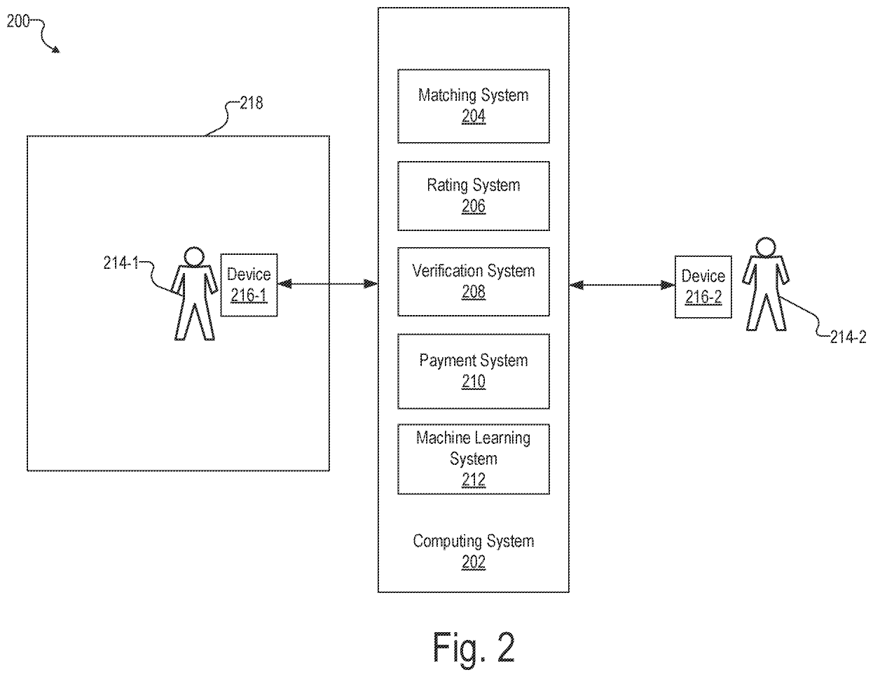

FIG. 2 shows an exemplary configuration 200 of a computing system 202 (e.g., an implementation of system 100) configured to optimize matches of shifts and operatives. As shown, computing system 202 includes various subsystems, such as a matching system 204, a rating system 206, a verification system 208, a payment system 210, and a machine learning system 212, which may be configured to determine and/or optimize a match between a shift and an operative as described herein. These subsystems may be implemented in any suitable manner by computing system 202, such as on a same computing device, a plurality of computing devices, as separate systems or as components of one or more combined systems, etc. While configuration 200 shows computing system 202 as including matching system 204, rating system 206, verification system 208, payment system 210, and machine learning system 212, in some examples, computing system 202 may include additional or fewer systems and/or components. For instance, in some examples, computing system 202 may omit one or more of rating system 206, verification system 208, payment system 210, and/or machine learning system 212.

Configuration 200 shows operatives 214 (e.g., operatives 214-1 and 214-2) using devices 216 (e.g., devices 216-1 and 216-2) to interact with computing system 202. Devices 216 may include any suitable devices capable of communicating over a network and providing and receiving data. For example, devices 216 may include smartphones, tablets, laptops, desktops, smart watches, wearable devices, headsets, augmented reality (AR) devices, virtual reality (VR) devices, or any other suitable devices.

In this example, operative 214-1 may be an employee of an entity 218 seeking to fill shifts associated with a task. An entity may include any suitable organization that hires employees on a temporary, contract, and/or shift basis, such as a company, a factory, a restaurant, a store, a call center, a healthcare facility, or any other such organization. A task may include any work or piece of work that furthers a process or goal associated with the entity. A shift may include any suitable period of time allocated for a performing of the task and that is to be filled for performance by an operative.

Operative 214-1 may use device 216-1 to provide a request from entity 218 to fill a shift associated with a task. Computing system 202 (e.g., matching system 204) may receive the request and access values for a set of shift criteria associated with entity 218 and the shift. The shift criteria may include any characteristics of entity 218 and/or the shift that may affect an operative's decision to take the shift. For example, the shift criteria may include characteristics such as a location of the entity or shift, a proximity of the entity to an operative, a time of the shift, a length of the shift, a description of the task, a type of skill to be used for performing the task, a level of skill to be used for performing the task, a certification for performing the task, evaluations of the entity from operatives, a safety rating of the entity, a pay rate for the shift, a timeliness of payment by the entity, linguistic compatibilities (e.g., different language options), industry-specific characteristics, and/or any other suitable characteristic.

Computing system 202 may access values of the shift criteria associated with the shift (and entity 218) in any suitable manner. For instance, values may be provided by operative 214-1, such as information regarding the time and length of the shift, the skills and/or certifications for performing the task, the pay rate for the shift, etc. Additionally or alternatively, values may be based on previous ratings of entity 218, which may be stored by computing system 202 (e.g., rating system 206) and/or accessed from any other suitable data source (e.g., other storage systems in communication with computing system 202, external rating systems, etc.).

Computing system 202 may access operative criteria associated with operatives to determine compatibility ratings for operatives with the shift. For example, operative 214-2 may use device 216-2 to request available potential shifts for operative 214-2. Computing system 202 may access values for a set of operative criteria associated with operative 214-2. The operative criteria may include any suitable characteristics of an operative that may affect an entity's decision to hire the operative. For example, the operative criteria may include characteristics such as a location of the operative, a proximity of the operative to the entity, a time availability of the operative, a type of skill possessed by the operative, a level of skill possessed by the operative, a certification possessed by the operative, evaluations of the operative from entities, a performance (e.g., efficiency, productivity, etc.) metric of the operative, a safety metric of the operative, a completion rate of previous shifts by the operative, pay rates for the operative on previous shifts, linguistic compatibilities (e.g., fluency in different languages), industry-specific characteristics, or any other suitable characteristic.

Computing system 202 may access values of the operative criteria associated with operative 214-2 in any suitable manner. For instance, operative 214-2 may provide values for criteria, such as particular criteria values operative 214-2 is looking to match with a potential shift (e.g., time availability for the operative, skills possessed by the operative, etc.). Such operative criteria values for operative 214-2 may be provided in any suitable manner, such as input by operative 214-2, associated with a profile and/or an account for operative 214-2, based on questions answered by operative 214-2, based on information associated with device 216-2 (e.g., a location of device 216-2), etc. Additionally or alternatively, operative criteria values may be determined in any other suitable manner, such as based on data generated based on previous shifts worked by operative 214-2 for entity 218 and/or other entities, etc.

Computing system 202 may choose to access the values of the set of operative criteria specifically for operative 214-2 in any suitable manner. For instance, computing system 202 may publish information (e.g., on a website, through an app, etc.) regarding the available shift (e.g., values for some or all of the set of shift criteria). Consequently, potential operatives, including operative 214-2, may access the information and discover and select and/or apply for available shifts that the operatives may wish to fill. Additionally or alternatively, computing system 202 may receive a request from operative 214-2 for potential shifts that may be relevant to operative 214-2. Additionally or alternatively, computing system 202 may search a database of operatives for operatives, including operative 214-2, relevant to the shift.

Computing system 202 may determine, based on the values for the set of shift criteria and the values for the set of operative criteria, a value for a compatibility rating of operative 214-2 with the shift. The compatibility rating may be implemented in any suitable manner, such as a rating with binary values (e.g., match or not a match) or a plurality of values (e.g., a numerical scale, a set of possible values, a percentage value, etc.) or a combination (e.g., a plurality of values with a threshold value that signifies a match and/or not a match).

Computing system 202 may determine the compatibility rating in any suitable manner. For example, the compatibility rating of operatives with a shift may be a weighted combination of the set of operative criteria. The weighted combination may combine the set of operative criteria with any suitable weighting, such as weighting each value of the set of operative criteria by 1/N, where N is the number of operative criteria in the set. Additionally or alternatively, the weighting may be adjusted and/or determined based on input provided by entity 218. Such an adjustment may allow the weighting to be customizable for each entity to dictate how important each criteria in the set of operative criteria is to the entity, relative to the other criteria. Input for customized weighting may be provided in any suitable manner. For instance, operative 214-1 may provide to computing system 202 specific values for weightings, values on a scale of importance (e.g., a value on a scale of 1-5 or any other scale for each criteria), values via any suitable tools in a user interface (e.g., a slider tool, a dropdown selection, a radio button, etc.), etc. For example, computing system 202 may provide to operative 214-1 a slider tool for each criteria via which operative 214-1 may indicate an importance of the criteria. Additionally or alternatively, weightings may include particular criteria that are required so that operatives without a particular value for the criteria (e.g., possessing a skill necessary for the task) may be disqualified (e.g., assigned a minimum compatibility rating value, indicated as not a match, etc.). Additionally or alternatively, weightings may be determined based on ratings of previous operatives, such as by machine learning system 212 deriving a weighting of the criteria that results in operatives that are rated highly by entity 218. For example, machine learning system 212 and/or computing system 202 may provide recommended weighting of criteria based on ratings provided by operative 214-1 of other criteria and/or a desired output (e.g., a particular throughput, efficiency, error rate, etc.).

Computing system 202 may provide an output based on the value of the compatibility rating of operative 214-2 with the shift. The output may be any suitable output to entity 218 (e.g., device 216-1) and/or operative 214-2 (e.g., device 216-2). For example, the output may be an indication of a match between operative 214-2 and the shift. Additionally or alternatively, the output may be a list of potential operatives, which may include operative 214-2, provided to entity 218. The list of operatives may be determined based on respective values of the compatibility rating for each operative with the shift. The list may be ordered and/or tiered based on the values of the compatibility rating.

As described, computing system 202 may receive a request from operative 214-2 for potential shifts that may be relevant to operative 214-2. Computing system 202 may determine the potential shifts for operative 214-2 in a manner similar to computing system 202 determining potential operatives for a shift for entity 218. For instance, computing system 202 may determine respective values for a compatibility rating for shifts with operative 214-2 based on respective values for the set of shift criteria for each of the shifts. The compatibility rating for shifts with operative 214-2 may be implemented in any suitable manner, such as a weighted combination of shift criteria, which, similar to the compatibility rating for operatives, may be weighted in any suitable manner. For example, the weighting of the combination of shift criteria may be customized based on input provided by operative 214-2 and/or based on a weighting derived by computing system 202 based on ratings from operative 214-2 of previous shifts and/or entities. Input for customized weighting may be provided in any suitable manner. For instance, operative 214-2 may provide to computing system 202 specific values for weightings, values on a scale of importance (e.g., a value on a scale of 1-5 or any other scale for each criteria), values via any suitable tools in a user interface (e.g., a slider tool, a dropdown selection, a radio button, etc.), etc. For example, computing system 202 may provide to operative 214-2 a slider tool for each criteria via which operative 214-2 may indicate an importance of the criteria. The output provided by computing system 202 may further include a list of potential shifts for operative 214-2, which may be ordered and/or tiered based on respective values of the compatibility rating for the shifts.

In some examples, computing system 202 may receive an indication from entity 218 (e.g., via device 216-1) of a selection of an operative (e.g., operative 214-2) to fill the shift that entity 218 requested to be filled. Further, computing system 202 may receive an indication from operative 214-2 of a corresponding selection of the shift (e.g., a selection of the shift from a list of potential shifts, an acceptance of a selection made by entity 218 of operative 214-2 for the shift, etc.). Based on the matching selections, computing system 202 may facilitate operative 214-2 performing the task for the shift selected. For instance, computing system 202 may output an indication of a match of operative 214-2 with the shift to both operative 214-2 and entity 218 (e.g., via devices 216). Providing such an indication to both parties may allow entity 218 to improve retention rates of operatives and decrease no shows for shifts compared to conventional systems. In some examples, computing system 202 may further improve retention rates by preventing operative 214-2 from selecting more than one shift for a particular time period and/or providing an indication to entity 218 if operative 214-2 selects a different shift that would prevent operative 214-2 from working a previously selected shift with entity 218.

In some examples, the matching of shifts and operatives may be based on dynamic values for shift criteria and/or operative criteria. For instance, based on demand for operatives or shifts (e.g., based on a time of day, a type of skill, a level of skill, etc.), the pay rate offered for the shift may change. The pay rates and/or other dynamic values may be determined based on algorithms (e.g., machines learning algorithms and/or any other suitable algorithm) to optimize a number of matches between shifts and operatives and/or any suitable variable.

Additionally, computing system 202 (e.g., verification system 208) may facilitate verification of operative 214-2 and/or entity 218. Computing system 202 may verify operative 214-2 in any suitable manner. For example, computing system 202 may verify that operative 214-2 is who operative 214-2 claims to be. Computing system 202 may prompt for and receive images and/or information associated with identification (ID) credentials of operative 214-2, such as a driver's license, a passport, a social security card, etc. Computing system 202 may further conduct background checks of operative 214-2, such as a criminal background check, a credit check, an employment history check, etc. Such verifications may be stored and/or associated with a profile of operative 214-2 so that such verifications may be bypassed for future shifts that operative 214-2 works with entity 218 and/or any entity. Computing system 202 may authenticate operative 214-2 to a stored profile in any suitable manner, such as a fingerprint scan, retinal scan, facial recognition, or any other biometric scan, a password, etc., which may be input through device 216-2 and/or through additional verification devices and/or stations located at entity 218 and/or locations trusted by entity 218. In this manner, systems described herein may allow entities to more efficiently and seamlessly hire operatives to work shifts compared to conventional systems.

Additionally or alternatively, computing system 202 may verify skills claimed by operative 214-2. Computing system 202 may verify the skills in any suitable manner, such as by accessing and validating certifications, checking with previous employers and/or other entities, etc. Computing system 202 may additionally or alternatively provide a skill assessment to operative 214-2 (e.g., a diagnostic questionnaire or test that determines adequate possession and/or level of the skill), etc. Such an assessment may be generated based on data captured by sensors of entity 218 of operatives performing the task and/or applying the skill. Examples of such data, sensors, and generating assessments based on such data are described further herein.

Additionally or alternatively, computing system 202 may verify aspects of entity 218. For instance, computing system 202 may verify, based on data captured by sensors at entity 218 whether equipment and/or environments of entity 218 are safe and/or match a safety metric associated with entity 218. Additionally or alternatively computing system 202 may verify any other suitable aspects of entity 218.

Furthermore, in some examples, computing system 202 (e.g., payment system 210) may facilitate payment of operative 214-2 for the shift. For example, computing system 202 may provide and/or access legal documents, forms, and/or financial information (e.g., bank account details, social security numbers, tax identification numbers, etc.) associated with payment from entity 218 and/or payment to operative 214-2. Such documents and forms may be stored with profiles associated with entity 218 and/or operative 214-2, respectively. Additionally or alternatively, forms may be pre-filled with information stored in profiles so that entity 218 may hire potential operatives efficiently as well as operative 214-2 working at potential entities efficiently with a streamlined onboarding process.

Additionally or alternatively, computing system 202 may facilitate payment of operative 214-2 for the shift by sending the payment, authorizing the payment, and/or directing an external system to send the payment to a financial account associated with operative 214-2.

Furthermore, in some examples, computing system 202 (e.g., rating system 206) may facilitate evaluation and rating of operative 214-2 and/or entity 218 based on operative 214-2 working the shift. For instance, operative 214-2 may provide one or more ratings of entity 218 upon completion of the shift, evaluating entity 218 and/or the shift based on the experience. The ratings may include categories that correspond to or are included in the set of entity criteria that computing system 202 uses to determine compatibility ratings. Thus, the values of the ratings provided by operative 214-2 may be incorporated into the values of entity criteria for entity 218 and affect compatibility ranking values of entity 218 with operative 214-2 and/or other operatives in the future. In some examples, rating values of entities provided by operative 214-2 may be given more weight in determining compatibility of shifts to operative 214-2 than rating values of the entities provided by other operatives.

Additionally or alternatively, entity 218 may provide one or more ratings of operative 214-2 based on a performance evaluation of operative 214-2 on the shift. For example, a supervisor and/or other operative may observe operative 214-2 while working on the shift and provide feedback to computing system 202. The feedback may include values for categories that correspond to or are included in the set of operative criteria that computing system 202 uses to determine compatibility ratings. In some examples, such evaluation criteria may be agreed upon with and/or provided to operative 214-2 prior to the working of the shift. Additionally or alternatively, one or more rating values may be based on data captured by sensors of entity 218 while operative 214-2 is performing the task (e.g., a performance metric, a safety metric, etc.). Such data and sensors are described further herein. Ratings of operative 214-2 may be incorporated into the values of operative criteria for operative 214-2 and affect compatibility ranking values of operative 214-2 with shifts for entity 218 and/or other entities in the future. In some examples, rating values of operatives provided by entity 218 may be given more weight in determining compatibility of operatives to shifts of entity 218 than rating values of operatives provided by other entities.

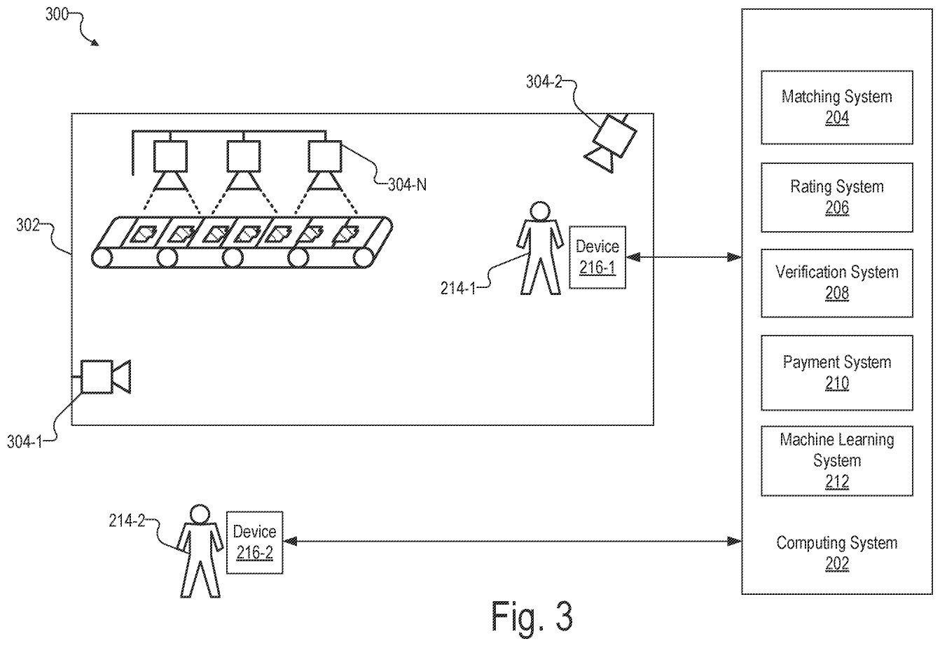

FIG. 3 shows an exemplary configuration 300 of a system within which computing system 202 may operate to perform shift and operative match optimization in an industrial environment. An industrial environment may include any environment that is associated with and/or related to any industrial process, such as manufacturing processes, warehousing processes, fulfillment processes, transportation processes (e.g., physical goods delivery processes), processes associated with providing services (e.g., processes associated with operating a content delivery network, a data center, etc.), and/or any other industrial process. For example, the industrial environment shown in configuration 300 is a factory floor 302 (e.g., associated with entity 218).

As described, an operative (e.g., operative 214-1) may use a device (e.g., device 216-1) to provide a request to computing system 202 to fill a shift on factory floor 302. Computing system 202 may also receive a request from another operative (e.g., operative 214-2) using another device (e.g., device 216-2) for potential shifts for operative 214-2 to work. As described herein, computing system 202 may match operative 214-2 to the shift.

As shown in configuration 300, factory floor 302 may include sensors 304 (e.g., sensors 304-1 through 304-N) that may capture data of tasks being performed and provide the data to computing system 202. Sensors 304 may include any component or device (including, in some examples, devices 216 and/or sensors of devices 216) configured to capture data of an environment of the component or device. Sensors 304 may be further configured to provide the data, such as by communicating over a network and/or providing the data to a device for communicating over the network. For example, sensors 304 may include image sensors (e.g., cameras), scanners (e.g., radio frequency identification (RFID) scanners, barcode scanners, etc.), thermal sensors, audio sensors (e.g., microphones), motion sensors, light sensors, force sensors, kinematic sensors, electromagnetic sensors, machine-specific sensors, any other suitable sensors, or any combination or sub-combination of such sensors.

Sensors 304 may capture data that may be used for task recognition, evaluation, and/or optimization. For example, such data may include location data, image data, video data, audio data, movement data, kinematics data, etc. associated with operatives 214 and/or tasks performed by operatives 214. Sensors 304 may further capture data such as product throughput data, product quality compliance data, machine performance data, and any other suitable data. Sensors 304 may provide the data to computing system 202.

Computing system 202 may access (e.g., receive, retrieve, etc.) the data captured by sensors 304. For example, computing system 202 (and/or one or more subsystems of computing system 202) may include technologies such as cellular network technologies, MEC server communication technologies, Wi-Fi technologies, etc. and/or any combination of such technologies so that computing system 202 may be able to operate with multiple types of devices 216 and/or sensors 304 for task recognition, evaluation, and/or optimization.

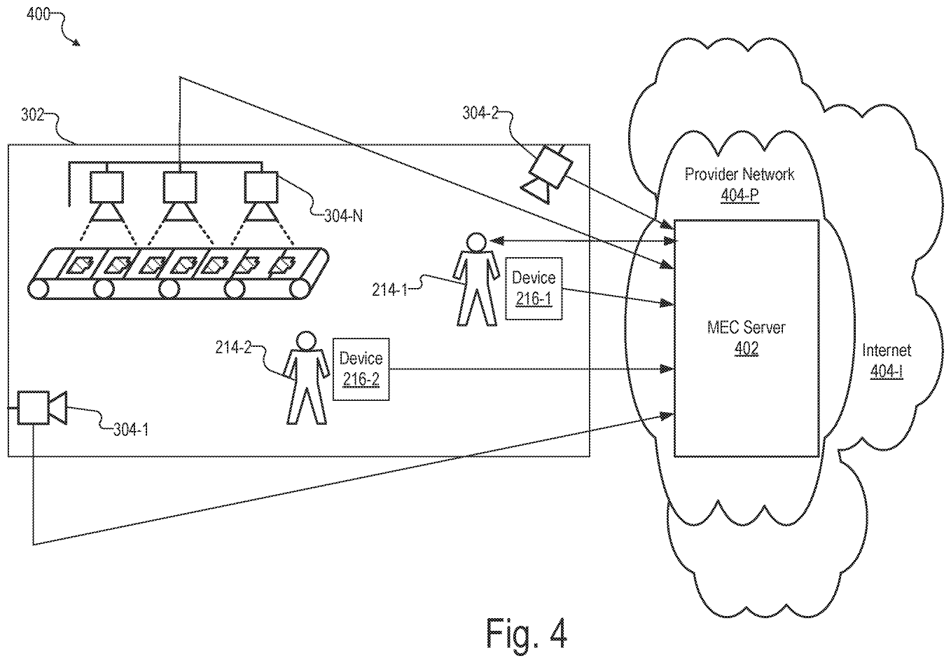

For example, FIG. 4 shows another exemplary configuration 400 of a system in which computing system 202 is implemented using a MEC server 402 integrated within a network 404 (including a provider network 404-P portion and an Internet 404-1 portion). Implementing computing system 202 with MEC server 402 may allow computing system 202 to perform resource-intensive computing tasks (e.g., communicating with a plurality of devices 216 and/or sensors 304, locating operatives 214 and/or objects associated with tasks, analyzing a plurality of data streams, performing machine learning algorithms, etc.) with a very low latency.

Configuration 400 shows operative 214-2 on factory floor 302, where operative 214-2 may be working a shift matched by computing system 202. Computing system 202 may receive data captured by sensors 304 of operative 214-2 performing one or more tasks while working the shift and provide automated performance evaluation metrics based on the data. For instance, the data may include videos of operative 214-2 performing a task associated with the shift. Computing system 202 may analyze the videos (e.g., using machine vision algorithms such as facial recognition, behavioral recognition, motion recognition, object detection, etc.) to identify operative 214-2 performing the task. Computing system 202 may compare the videos of operative 214-2 with reference videos to evaluate performance of the task. For instance, computing system 202 may access training videos for various tasks that may be performed by operative 214-2.

Additionally or alternatively, computing system 202 may determine, based on data from sensors 304, performance metrics such as productivity, efficiency, throughput, etc. In some examples, data may further include data received from other systems associated with the environment, such as quality assurance (QA) systems, enterprise resource planning (ERP) systems, warehouse management systems, time sheet/time recordation systems, etc. Such systems may provide additional data associated with the performance of the task, such as quality data, throughput data, process flow data, production flow data, data indicating completion of the task, data indicating time spent on the task, individual performance records data, etc. In some examples, some or all of such systems may be implemented by computing system 202.

Computing system 202 may include such automated performance evaluation of operative 214-2 performing the task on the shift as some or all of the ratings provided by entity 218 of operative 214-2 upon completion of the shift. In some examples, such automated performance evaluations may be provided to an operative of entity 218 who may review, edit, and/or approve the evaluations for providing ratings to computing system 202.

In some examples, the data captured by sensors 304 of performance of the task by operative 214-2 (and/or other operatives) may be used to generate training and/or testing materials. For instance, video data of operative 214-2 performing the task may be used to generate a training video for performing the task. Additionally or alternatively, video data may be used to generate questions for a test for future potential operatives to ensure the potential operatives can identify aspects of the task and/or performance of the task. Testing materials may be provided to operatives for verifying skills of the operatives. Training materials may be provided to operatives for developing new skills, certification of skills, etc.

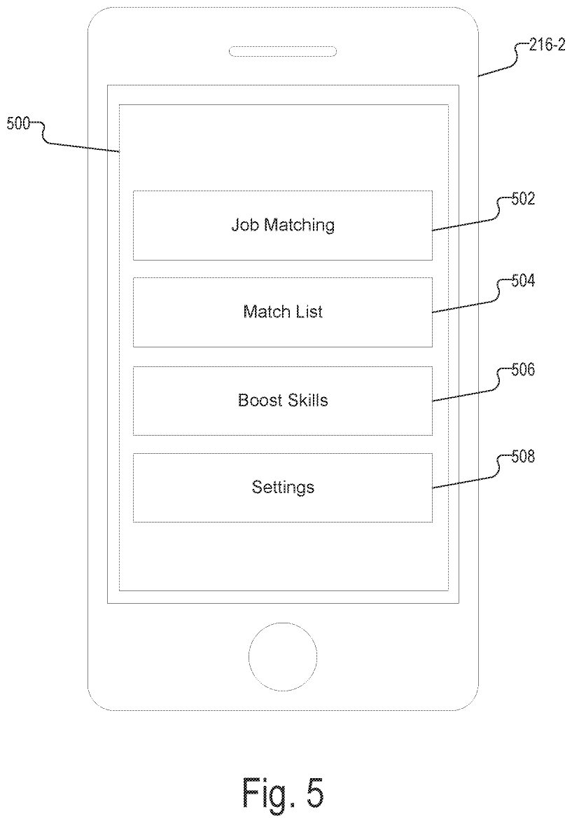

For example, FIG. 5 shows an exemplary user interface 500 that may be implemented by computing system 202 and provided to an operative (e.g., operative 214-2) via a device (e.g., device 216-2). For example, user interface 500 may be an interface of an application (app) on device 216-2 via which computing system 202 provides and receives data. As shown, user interface 500 shows a menu of options operative 214-2 may select. For instance, user interface 500 shows a job matching option 502, a match list option 504, a boost skills option 506, and a settings option 508. While user interface 500 shows these particular options, user interface 500 may include any suitable additional options, fewer options, etc.

Job matching option 502 may allow operative 214-2 to enter values for shift criteria on which computing system 202 may base a search of potential shifts for operative 214-2. Match list option 504 may show potential shifts that computing system 202 determines may be relevant to operative 214-2 based on values of operative criteria for operative 214-2 and values of shift criteria for the potential shifts. For either option, computing system 202 may provide for display compatibility ratings for potential shifts with operative 214-2. Such compatibility ratings may include breakdowns of the compatibility ratings, such as some or all of the criteria and how well they match between a shift and operative 214-2. Such breakdowns may indicate that operative 214-2 is less compatible with certain shifts due to lacking skills and/or lacking level of skills. To improve upon such skills, operative 214-2 may select boost skills option 506. Examples of implementations of boost skills option 506 are further described herein.

Settings option 508 may include any suitable settings, such as settings for the app and/or profile settings associated with operative 214-2. For example, settings option 508 may enable operative 214-2 to provide information associated with operative 214-2 that may be used by computing system 202 for matching operative 214-2 with shifts and/or facilitating operative 214-2 working matched shifts. Such information may include identification information, operative criteria values, verification information, payment information, etc., as described herein.

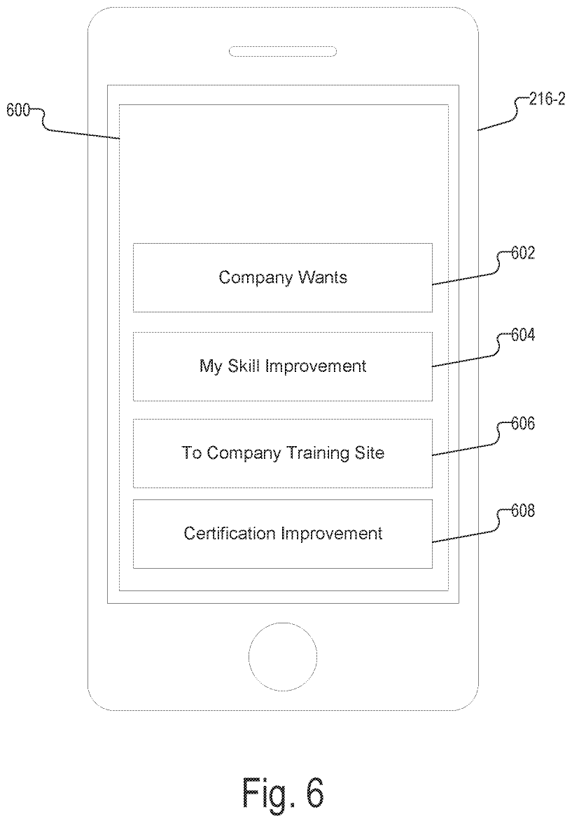

FIG. 6 shows another exemplary user interface 600 that may be implemented by computing system 202 and provided to an operative (e.g., operative 214-2) via a device (e.g., device 216-2). User interface 600 may show an example of an interface under boost skills option 506 of user interface 500. User interface 600 may show a display element 602 that may display information about desired skills required and/or recommended by an entity (e.g., entity 218). The desired skills may be associated with a potential shift and/or more generally associated with tasks performed for entity 218. User interface 600 may show another display element 604 that may display information that shows skills that may be developed (e.g., improved and/or acquired) by operative 214-2 to meet the skills desired by entity 218 as shown in display element 602.

User interface 600 may include an option 606 that links to a training site of entity 218 where operative 214-2 may develop skills. The training site may include any suitable training materials, including as described herein. Additionally or alternatively, entity 218 may provide training on the job and may indicate as such on the training site. Such availability of training may be included as shift criteria and/or a desire for such training as operative criteria.

User interface 600 may further include another option 608 that links to affiliate sites where operative 214-2 may also develop skills and/or obtain certifications. Additionally or alternatively, computing system 202 may facilitate obtaining of certifications based on shifts completed by operative 214-2 (e.g., by verifying hours worked toward certification requirements, etc.).

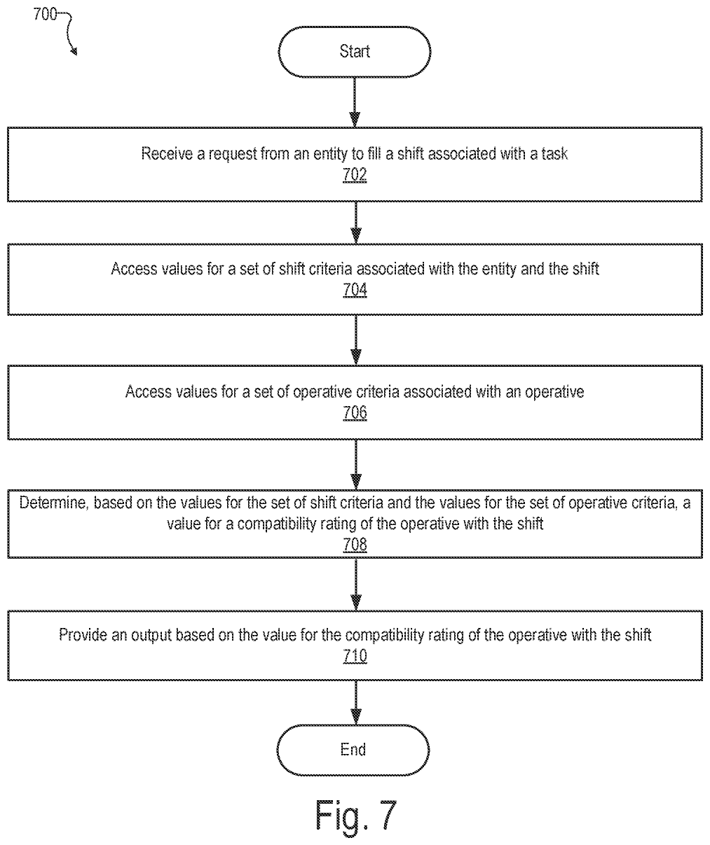

FIG. 7 illustrates an exemplary method 700 for shift and operative match optimization. While FIG. 7 illustrates exemplary operations according to one embodiment, other embodiments may omit, add to, reorder, and/or modify any of the operations shown in FIG. 7. One or more of the operations shown in FIG. 7 may be performed by system 100, any components included therein, and/or any implementation thereof.

In operation 702, a computing system receives a request from an entity to fill a shift associated with a task. Operation 702 may be performed in any of the ways described herein.

In operation 704, the computing system accesses values for a set of shift criteria associated with the entity and the shift. Operation 704 may be performed in any of the ways described herein.

In operation 706, the computing system accesses values for a set of operative criteria associated with an operative. Operation 706 may be performed in any of the ways described herein.

In operation 708, the computing system determines, based on the values for the set of shift criteria and the values for the set of operative criteria, a value for a compatibility rating of the operative with the shift. Operation 708 may be performed in any of the ways described herein.

In operation 710, the computing system provides an output based on the value for the compatibility rating of the operative with the shift. Operation 710 may be performed in any of the ways described herein.

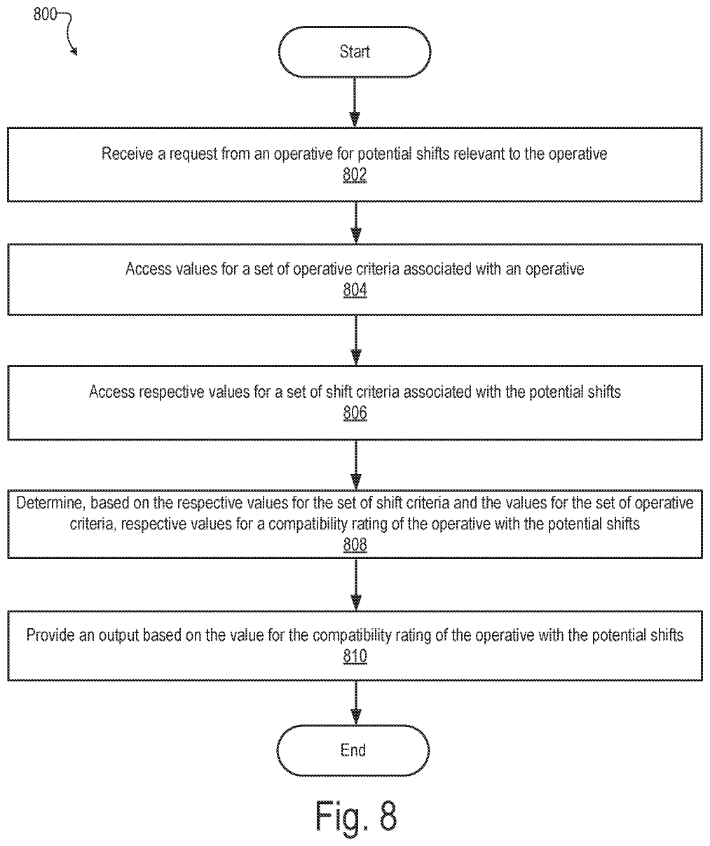

FIG. 8 illustrates another exemplary method 800 for shift and operative match optimization. While FIG. 8 illustrates exemplary operations according to one embodiment, other embodiments may omit, add to, reorder, and/or modify any of the operations shown in FIG. 8. One or more of the operations shown in FIG. 8 may be performed by system 100, any components included therein, and/or any implementation thereof.

In operation 802, a computing system receives a request from an operative for potential shifts relevant to the operative. Operation 802 may be performed in any of the ways described herein.

In operation 804, the computing system accesses values for a set of operative criteria associated with an operative. Operation 804 may be performed in any of the ways described herein.

In operation 806, the computing system accesses respective values for a set of shift criteria associated with the potential shifts. Operation 806 may be performed in any of the ways described herein.

In operation 808, the computing system determines, based on the respective values for the set of shift criteria and the values for the set of operative criteria, respective values for a compatibility rating of the operative with the potential shifts. Operation 808 may be performed in any of the ways described herein.

In operation 810, the computing system provides an output based on the value for the compatibility rating of the operative with the potential shifts. Operation 810 may be performed in any of the ways described herein.

In certain embodiments, one or more of the systems, components, and/or processes described herein may be implemented and/or performed by one or more appropriately configured computing devices. To this end, one or more of the systems and/or components described above may include or be implemented by any computer hardware and/or computer-implemented instructions (e.g., software) embodied on at least one non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

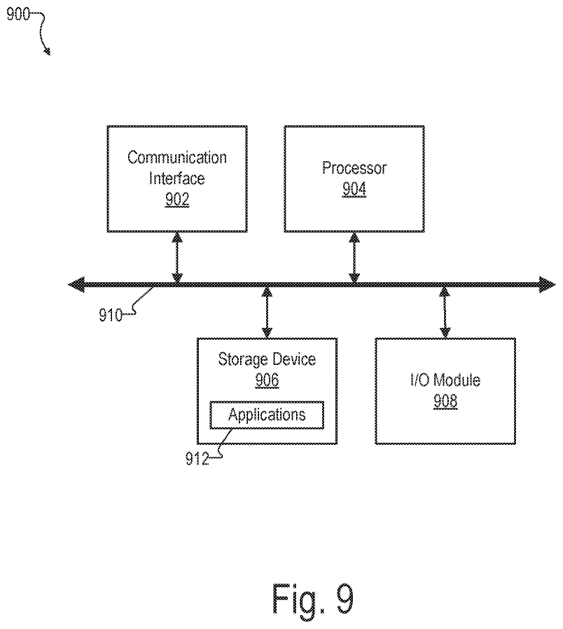

FIG. 9 illustrates an exemplary computing device 900 that may be specifically configured to perform one or more of the processes described herein. As shown in FIG. 9, computing device 900 may include a communication interface 902, a processor 904, a storage device 906, and an input/output (“l/O”) module 908 communicatively connected via a communication infrastructure 910. While an exemplary computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, an audio/video connection, and any other suitable interface.

Processor 904 generally represents any type or form of processing unit capable of processing data or interpreting, executing, and/or directing execution of one or more of the instructions, processes, and/or operations described herein. Processor 904 may direct execution of operations in accordance with one or more applications 912 or other computer-executable instructions such as may be stored in storage device 906 or another computer-readable medium.

Storage device 906 may include one or more data storage media, devices, or configurations and may employ any type, form, and combination of data storage media and/or device. For example, storage device 906 may include, but is not limited to, a hard drive, network drive, flash drive, magnetic disc, optical disc, RAM, dynamic RAM, other non-volatile and/or volatile data storage units, or a combination or sub-combination thereof. Electronic data, including data described herein, may be temporarily and/or permanently stored in storage device 906. For example, data representative of one or more executable applications 912 configured to direct processor 904 to perform any of the operations described herein may be stored within storage device 906. In some examples, data may be arranged in one or more databases residing within storage device 906.

I/O module 908 may include one or more I/O modules configured to receive user input and provide user output. One or more I/O modules may be used to receive input for a single virtual experience. I/O module 908 may include any hardware, firmware, software, or combination thereof supportive of input and output capabilities. For example, I/O module 908 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 900. For example, one or more applications 912 residing within storage device 906 may be configured to direct processor 904 to perform one or more processes or functions associated with processing facility 104 of system 100. Likewise, storage facility 102 of system 100 may be implemented by or within storage device 906.

To the extent the aforementioned embodiments collect, store, and/or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
receiving, by a computing system, a request from an entity to fill a shift associated with a task;
accessing, by the computing system, values for a set of shift criteria associated with the entity and the shift;
accessing, by the computing system, values for a set of operative criteria associated with an operative;
determining, by the computing system and based on the values for the set of shift criteria and the values for the set of operative criteria, a value for a compatibility rating of the operative with the shift; and
providing, by the computing system, an output based on the value for the compatibility rating of the operative with the shift.

2. The method of claim 1, wherein the set of shift criteria comprises at least one of:
a location of the entity;
a proximity of the entity to the operative;
a time of the shift;
a length of the shift;
a type of skill for performing the task;
a level of skill for performing the task;
a certification for performing the task;
evaluations of the entity from operatives;
a safety rating of the entity; or
a pay rate for the shift.

3. The method of claim 1, wherein the set of operative criteria comprises at least one of:
a location of the operative;
a proximity of the operative to the entity;
a time availability of the operative;
a type of skill possessed by the operative;
a level of skill possessed by the operative;
a certification possessed by the operative;
evaluations of the operative from entities;
a performance metric of the operative;
a safety metric of the operative;
a completion rate of previous shifts by the operative; or
pay rates for the operative on the previous shifts.

4. The method of claim 1, wherein:
the compatibility rating is based on a weighted combination of the set of operative criteria; and
values for weighting the weighted combination are based on input from the entity.

5. The method of claim 1, wherein:
the method further comprises generating, by the computing system, a list of operatives including the operative, the list of operatives based on respective values for the compatibility rating of the operatives with the shift; and
the providing the output comprises providing to the entity the list of operatives.

6. The method of claim 5, wherein:
the method further comprises:
receiving, by the computing system, an additional request from the operative for a list of potential shifts, and
generating, by the computing system, the list of potential shifts based on respective values for an additional compatibility rating of the potential shifts with the operative, the list of potential shifts including the shift; and
the providing the output comprises providing to the operative the list of potential shifts.

7. The method of claim 6, wherein:
the additional compatibility rating is based on an additional weighted combination of the set of shift criteria; and
values for weighting the additional weighted combination are based on input from the operative.

8. The method of claim 6, further comprising:
receiving, by the computing system, a first selection, by the entity, of the operative from the list of operatives;
receiving, by the computing system, a second selection, by the operative, of the shift from the list of potential shifts; and
outputting, by the computing system and to the entity and the operative, an indication of a match of the operative with the shift.

9. The method of claim 8, further comprising:
receiving, by the computing system, a value for a rating of the entity by the operative, the rating comprising at least one of the shift criteria of the set of shift criteria and the value for the rating based on an experience of the operative on the shift.

10. The method of claim 8, further comprising:
receiving, by the computing system, a value for a rating of the operative by the entity, the rating comprising at least one of the operative criteria of the set of operative criteria and the value for the rating based on a performance evaluation of the operative on the shift.

11. The method of claim 10, wherein the performance evaluation is based on a performance metric determined based on data captured by at least one sensor while the operative performs the task.

12. The method of claim 1, wherein the entity is associated with an industrial environment.

13. A system comprising:
a memory storing instructions; and
a processor communicatively coupled with the memory and configured to execute the instructions to:
receive a request from an entity to fill a shift associated with a task;
access values for a set of shift criteria associated with the entity and the shift;
access values for a set of operative criteria associated with an operative;
determine, based on the values for the set of shift criteria and the values for the set of operative criteria, a value for a compatibility rating of the operative with the shift; and
provide an output based on the value for the compatibility rating of the operative with the shift.

14. The system of claim 13, wherein:
the compatibility rating is based on a weighted combination of the set of operative criteria; and
values for weighting the weighted combination are based on input from the entity.

15. The system of claim 13, wherein:
the processor is further configured to execute the instructions to generate a list of operatives including the operative, the list of operatives based on respective values for the compatibility rating of the operatives with the shift; and
the providing the output comprises providing to the entity the list of operatives.

16. The system of claim 15, wherein:
the processor is further configured to execute the instructions to:
receive an additional request from the operative for a list of potential shifts, and
generate the list of potential shifts based on respective values for an additional compatibility rating of the potential shifts with the operative, the list of potential shifts including the shift; and
the providing the output comprises providing to the operative the list of potential shifts.

17. The system of claim 16, wherein:
the additional compatibility rating is based on an additional weighted combination of the set of shift criteria; and
values for weighting the additional weighted combination are based on input from the operative.

18. The system of claim 16, wherein the processor is further configured to execute the instructions to:
receive a first selection, by the entity, of the operative from the list of operatives;
receive a second selection, by the operative, of the shift from the list of potential shifts; and
output, to the entity and the operative, an indication of a match of the operative with the shift.

19. A method comprising:
receiving, by a computing system, a request from an operative for potential shifts relevant to the operative;
accessing, by the computing system, values for a set of operative criteria associated with the operative;
accessing, by the computing system, respective values for a set of shift criteria associated with the potential shifts;
determining, by the computing system and based on the respective values for the set of shift criteria and the values for the set of operative criteria, respective values for a compatibility rating of the operative with the potential shifts; and
providing, by the computing system, an output based on the value for the compatibility rating of the operative with the potential shifts.

20. The method of claim 19, wherein:
the compatibility rating is based on a weighted combination of the set of shift criteria; and
values for weighting the weighted combination are based on input from the operative.
